(19) United States
(12) Patent Application Publication
(10) Pub. No.: US 2004/0238796 A1
(43) Pub. Date: Dec. 2, 2004

(54) Composite magnetic material prepared by compression forming of ferrite-coated metal particles and method for preparation thereof

(76) Inventor: Masanori Abe, Tokyo (JP)

Correspondence Address: Finnegan Henderson Farabow, Garrett & Dunner, 1300 I Street NW, Washington, DC, 20005, US

(21) Appl. No.: 10/486,285

(22) PCT Filed: Aug. 9, 2002
(86) PCT No.: PCT/JP02/08154

(30) Foreign Application Priority Data
Aug. 9, 2001 (JP) 2001-242192
Jan. 17, 2002 (JP) 2002-9210

(51) Int. Cl. H01B 1/00

(52) U.S. Cl. 252/500

(57) ABSTRACT

Fine ferromagnetic metal or intermetallic compound particles having a ferrite layer covering formed on the surface thereof are compression-formed to form a composite of the ferrite layer and the metal or intermetallic compound, thereby configuring a composite magnetic material which has the fine ferromagnetic metal or intermetallic compound particles electrically insulated from one another and magnetically connected to one another and exhibits a high saturation magnetization, high permeability and also high insulating property. The ferrite layer covering is preferably formed by ferrite plating, and particularly by ferrite plating with the aid of ultrasonic excitation. This composite magnetic material is provided with higher insulating property as the fine ferromagnetic particles and ultra-fine ferrite particles are mixed and compression-formed to form a composite. The ferrite layer preferably has an amorphous ferrite phase as a primary phase.

### TECHNICAL FIELD

The present invention relates to a composite magnetic material having a high insulating property and a high magnetic permeability and a method for production thereof, and more particularly to a composite magnetic material, which is produced by compression forming of fine ferromagnetic metal or intermetallic compound particles having the surface covered with ferrite and has both a high insulating property and a high magnetic permeability, and a method for production thereof.

### BACKGROUND ART

Ferrite, which is an oxide magnetic material, has a feature that its electrical resistivity is very high as compared with metal magnetic materials and has been used widely as a magnetic core to be used at a high frequency and a high speed. The ferrite, however, is an oxide magnetic substance showing ferrimagnetism and its saturation magnetization generally has a relatively small value of about 0.3 to 0.5 T. In recent years, the need for a magnetic material having a higher magnetic flux density has increased in order to miniaturize a magnetic device such as an inductance element with the miniaturization of electronic equipment, and a metallic-ferromagnetic substance having a saturation magnetization value larger than that of the ferrite has come to be used mostly. The metallic-ferromagnetic substance has an electrical resistivity of, for example, about 10⁻⁷Ω·m which is very small. Therefore, where the metallic-ferromagnetic substance is used at a high frequency or a high speed, it is configured into a multilayered thin film in order to suppress eddy current by an insulating layer held between the adjacent metal magnetic substance films for insulating. Thus, the magnetic permeability is prevented from being lowered by the eddy current, and the use at a high frequency or a high speed is made possible.

In the thin film having the eddy current suppressed as described above, skin depth δ indicating a depth that an electromagnetic wave penetrates in the magnetic metal film, which is given by the equation below, is used as a reference for selection of thickness d of one layer in the film.

$$δ = \sqrt{\frac{2 ρ}{2 π f μ}}$$

where ρ is an electrical resistivity, f is a frequency, μ is a magnetic permeability, and μ=μₛμ₀ (where μₛ is a relative permeability, and μ₀ is magnetic permeability of vacuum).

In the above equation, the magnetic permeability μ is treated as a real number, but the magnetic permeability μ comes to involve a retarded component at a high frequency, and the relative permeability μₛ is expressed as a complex relative permeability μ′-iμ″. The relative permeability has a frequency characteristic that real part μ′ decreases at a frequency near the one at which the thickness d of the thin film approaches δ and becomes substantially half at a frequency that the thickness d substantially agrees with δ, while imaginary part μ″ (loss) of the relative permeability increases. To use as a magnetic core, a frequency condition in which the thickness d is adequately smaller than δ is selected, while a condition in which d is brought close to δ is selected to use a loss positively.

When a metal magnetic material is formed into a thin film or to have a multilayered structure, there is a constraint that a magnetic path cannot be configured three-dimensionally because the magnetic path must be formed in the plane of the film. Therefore, the metal magnetic material is not formed to have a thin film or a multilayered shape but formed into fine particles, so that an electromagnetic wave can penetrate into the metal magnetic material, and the fine particles of the metal magnetic material are dispersed for mixing into an insulator of a resin or the like so as to electrically insulate the fine particles from one another. Where the metal magnetic material is formed into the fine particles, the same skin depth δ as that for the thin film described above is used as a reference for selection of the size d of the fine particles to suppress an eddy current.

The magnetic material formed into the fine particles did not have a spatial limitation on the forming of a magnetic path as in the magnetic material formed into the thin film, but the magnetic path was interrupted at many portions by a nonmagnetic insulator of a resin or the like and became discontinuous. Therefore, it was limited that a relative permeability obtained had a low value as compared with that of the magnetic material formed into the thin film. Conversely, when the particles were filled in high density so not to interrupt the magnetic path at many portions, the particles having a small electrical resistivity became electrically conducted to one another, and the magnetic material could not provide a high electrical resistivity.

The magnetic material such as ferrite to be used at a high frequency is used for a magnetic core or the like and also used for an electromagnetic-wave absorber worthy of mention. Lately, as a result of the development and popularization of electronic equipment and communications equipment, the need for prevention of electromagnetic waves from leaking from such equipment and interference between such equipment has increased. And, the magnetic material has come to play an important role as an electromagnetic-wave absorber to absorb unnecessary electromagnetic waves. The ferrite has high performance as an electromagnetic-wave absorber and has been used extensively (e.g., see Chapter 5, “Basic of electromagnetic wave interference and measures against it” written and edited by Shimizu and Sugiura, issued by The Institute of Electronics, Information and Communication Engineers (1995)).

Because a computer CPU and the like have become operated at speed faster and at a GHz band recently, electromagnetic waves produced from electronic equipment and communications equipment have become used at high frequencies (submicrowaves and microwaves), and devices and parts used therefor have become small in magnitude. To comply with the high frequency of electromagnetic waves generated from such equipment and parts and the miniaturization of the equipment and parts, a metal magnetic material having saturation magnetization larger than that of the ferrite is used as the electromagnetic-wave absorber, and a material having a smaller volume and capable of absorbing electromagnetic waves with higher efficiency is being developed. And, there are examples such as a thin film of a metal magnetic material and a multilayered film (Journal of Magnetics Society of Japan, Vol. 18, pp. 511 to 514 (1994)), a composite magnetic material which has as metal magnetic substance carbonyl iron particles dispersed into an insulating resin to enhance a filling ratio (Journal of Magnetics Society of Japan, Vol. 22, pp. 885 to 888 (1998)), and a composite magnetic material which has sendust (Fe-Si-Al alloy) particles dispersed into a polymer material. As described above, such composite magnetic materials have the magnetic path of each particle interrupted at many portions by an insulator of a resin or the like to become discontinuous. Therefore, they are under the constraint that the relative permeability is limited to a small value.

Then, it has been tried to eliminate the constraint on the magnetic material by combining the metal magnetic material and the ferrite. Japanese Patent Laid-Open Application No. SHO 56-38402 discloses an invention of a high density sintered magnetic substance in which the surface of a metal magnetic material of particles of 1 to 10 μm size are covered with a metal oxide magnetic material of a spinel composition. In this publication metal magnetic material particles are dispersed into a hydrosulfate solution of metal to be a ferrite component, adds sodium hydroxide to the solution to adjust a pH value to 12 to 13 so as to deposit ferrite particles, washes and dries the metal magnetic material and the deposited ferrite particles and sinters at a high temperature to produce a sintered body. This sintered magnetic substance is low in resistance, and high resistance is not obtained. It means that the ferrite particles deposited from the solution merely adhere to the metal magnetic material particles and do not cover the surface of the metal magnetic material particles, resulting in causing a low resistance by contacting the metal magnetic material particles to one another.

Japanese Patent Laid-Open Application No. HEI 11-1702 discloses a method for production of ferrous metal-ferritic oxide composite powder by adding an aqueous solution having metal salt of iron and divalent metal salt other than iron dissolved in an alkaline aqueous solution containing ferrous metal magnetic powder in a non-oxidizing atmosphere, adding an alkaline aqueous solution to adjust to a pH value of 7 or higher while heating to a prescribed temperature, and blowing oxygen into the resultant solution to form a ferrite oxide film on the surface of the ferrous metal magnetic powder. Thus, the formed body of the produced powder has a very low electrical resistivity of 1500 μΩm or below, and there is not produced a magnetic material which can be used at a high frequency. Therefore, the metallic powder is not sufficiently covered with ferrite, and the metallic powder particles come to contact to one another to cause low resistance.

### SUMMARY OF THE INVENTION

The present inventor has paid attention to the point that the above-described prior art is not a complete technology to securely cover the surface of the metal ferromagnetic particles with the ferrite layer, and made a study in order to obtain a composite magnetic material showing superior magnetic properties such as conventionally unattainable high electrical resistivity and high magnetic permeability by magnetic connection of fine ferromagnetic metal or intermetallic compound particles to one another through ferrite by establishing a technology to form a ferrite layer on the surface of fine ferromagnetic particles of metal or the like, and forming the ferrite layer firmly on the surface of a metal or intermetallic compound to form a firm film on the surface of the particles so as to form fine ferromagnetic metal or intermetallic compound particles having the surface covered.

The present inventor has positioned this study as one deployment of continuously conducted studies on ferrite plating and pursued the study. As a result, he has found that chemical bonding with high coordinate bonding property can be obtained between the fine ferromagnetic metal or intermetallic compound particles and the ferrite by ferrite plating the surface of the fine ferromagnetic metal or intermetallic compound particles, a firm and good covering can be made, and a magnetic material having high insulating property and high magnetic permeability can be obtained by forming fine particles having the surface of fine ferromagnetic metal or intermetallic compound particles covered with insulating ferrite. And he has made a further study to complete the present invention.

The composite magnetic material according to the present invention comprises fine ferromagnetic metal or intermetallic compound particles and a ferrite layer for covering the fine ferromagnetic metal or intermetallic compound particles, wherein the fine ferromagnetic metal or intermetallic compound particles covered with the ferrite layer are compressed to bulk form.

In the composite magnetic material of the invention, the ferrite layer is suitably formed by ferrite plating, and ferrite plating by ultrasonic excitation is particularly suitable.

In the composite magnetic material of the invention, the fine ferromagnetic metal or intermetallic compound particles which are uniformly and firmly covered with ferrite are subjected to the compression forming, so that the ferrite layer covers the surface of the fine ferromagnetic particles, and the ferrite layer plays a role to insulate the fine ferromagnetic metal or intermetallic compound particles from one another. Because the ferrite layer is a magnetic layer, it plays a role to magnetically connect the fine ferromagnetic metal or intermetallic compound particles to one another. By configuring as described above, a high electrical resistivity which heretofore could not be obtained can be obtained, eddy current is suppressed at a high frequency, and a composite magnetic material showing a high magnetic permeability has come to be available. Thus, it has become possible by the invention to obtain a composite magnetic material having a high relative permeability at a high frequency, e.g. a relative permeability of 40 or higher even at 100 MHz or higher.

For the composite magnetic material described above, the surface of the fine ferromagnetic metal or intermetallic compound particles can be covered with the uniform and firm ferrite layer by ferrite plating.

According to the present invention, the composite magnetic material is comprised of the fine ferromagnetic metal or intermetallic compound particles and the ferrite as the magnetic substance and does not need the presence of a nonmagnetic substance such as a polymeric binder, so that saturation magnetization can be prevented from decreasing by inclusion of the nonmagnetic material. And, because the ferrite covering layer is present between the particles, it is superior in heat resistance as compared with the case of using a polymeric binder.

The method for production of a composite magnetic material according to the present invention comprises a ferrite covering step for covering the surface of fine ferromagnetic metal or intermetallic compound particles with a ferrite layer by dispersing the fine ferromagnetic metal or intermetallic compound particles in a ferrite plating reaction solution and by ferrite plating; and a compression forming step for compression forming the fine ferromagnetic metal or intermetallic compound particles covered with the ferrite layer.

### BRIEF DESCRIPTION OF THE DRAWINGS

FIG. 1 is a diagram schematically showing states of filled fine particles of a composite magnetic material of the present invention, wherein FIG. 1A is a diagram showing a composite magnetic material having the surface of substantially spherical fine ferromagnetic metal or intermetallic compound particles coated with a ferrite layer, FIG. 1B is a diagram schematically showing a structure in that the fine ferromagnetic metal or intermetallic compound particles are mixed with a particle size distribution and have the surface covered with the ferrite layer so to enhance a particle filling ratio, and FIG. 1C is a diagram schematically showing a composite magnetic material which has the surface of fine ferromagnetic metal or intermetallic compound particles having magnetic shape anisotropy covered with insulating ferrite, directions aligned and formed.

FIG. 2 is a diagram showing a flow of a process according to a method of producing a composite magnetic material of the present invention.

FIG. 3 is a diagram schematically showing a reaction apparatus used to perform ferrite plating of fine particles according to one embodiment of the invention.

FIG. 4 is a diagram schematically showing a process for compression forming of fine particles coated by ferrite plating by warm forming according to an embodiment of a method of producing a composite magnetic material of the invention, wherein FIG. 4A is a diagram showing compression forming of a cylindrical formed body, and FIG. 4B is a diagram showing compression forming of a cylindrical or disc-like formed body.

FIG. 5 is a diagram schematically showing a result of observing a cross section of the multilayered ferrite covering layer of a composite magnetic material produced according to an embodiment of a method for production of a composite magnetic material of the invention through a transmission electron microscope, wherein FIG. 5A shows a covering layer for fine ferromagnetic particles resulting from three times of ferrite plating containing a drying step, and FIG. 5B shows a covering layer for fine ferromagnetic particles resulting from three times of ferrite plating including adsorption of a dextran monomolecular film.

### BEST MODE FOR CARRYING OUT THE INVENTION

As fine ferromagnetic metal or intermetallic compound particles for the composite magnetic material of the invention, various types of fine ferromagnetic particles, such as pure iron, iron-silicon alloy, iron-nickel alloy, sendust alloy, cobalt and cobalt alloy, nickel and nickel alloy, various types of amorphous alloys and other various types of soft magnetic materials, or Nd-Fe-B, Sm-Co and other magnetic anisotropic magnetic materials can be used.

It is desirable in the present invention that the fine ferromagnetic metal or intermetallic compound particles having a value of saturation magnetization larger than that of the covering layer ferrite are used. The covering layer ferrite has a saturation magnetic polarization value of about 0.5 T or less at normal temperature, while the fine ferromagnetic metal or intermetallic compound particles have desirably a saturation magnetization value larger than the above, more desirably 1 T or more in view of obtaining a conspicuous composing effect, and still more desirably 1.5 T or more in view of obtaining a more conspicuous composing effect. Therefore, as the fine ferromagnetic metal particles used for the present invention, fine particles of iron, iron-based alloy, cobalt, cobalt-based alloy or iron-cobalt-based alloy, which are fine ferromagnetic metal particles having high saturation magnetization, are particularly desirable.

The fine ferromagnetic metal or intermetallic compound particles for the composite magnetic material of the invention have a substantially spherical shape and can also have various types of shapes such as a disc, a flake, a needle or a particle and may also have the particles deformed in shape by compression forming.

Besides, the fine ferromagnetic metal or intermetallic compound particles for the composite magnetic material of the invention can have a particle size selected as described above with reference to skin depth δ at a frequency at which the composite magnetic material is used. To use as a magnetic core having only a weak loss, it is desirable that the fine ferromagnetic metal or intermetallic compound particles have an average particle diameter of less than δ, for example, ½ or less of δ, and more desirably ¼ or less of δ. In a case of using as a loss material, the average particle diameter of the fine ferromagnetic metal or intermetallic compound particles is preferably selected to have a value close to δ, for example, in a range of ½ to 2 times of δ. When the composite magnetic material of the invention is to be used in a frequency range of from a relatively low frequency of less than 1 MHz to a microwave range, the average particle diameter of the fine ferromagnetic metal or intermetallic compound particles can be selected from a rang of several hundreds μm to several nm depending on a frequency.

According to the present invention, the above-described various types of fine ferromagnetic metal or intermetallic compound particles can be used solely but can also be used as a combination of plural types of them depending on an object.

Ferrite generally has an electrical resistivity of 10¹ to 10⁵Ω·m or higher which is considerably higher than about 10⁻⁷Ω·m of the metal magnetic material. Therefore, the composite magnetic material of the invention can remarkably enhance electrical resistance between the particles by coating the surface of the fine ferromagnetic metal or intermetallic compound particles with a ferrite layer. The ferrite coating the surface of the fine ferromagnetic metal or intermetallic compound particles is desirably one having high electrical resistance in view of enhancing electrical resistance between the fine particles. As the ferrite having such high electrical resistance, NiZn ferrite, Co ferrite and Mg ferrite having a high value of electrical resistivity of 10⁴ to 10⁵Ω·m are available.

The ferrite used to coat the surface of the fine ferromagnetic metal or intermetallic compound particles desirably has high saturation magnetization. As the ferrite having high saturation magnetization and high electrical resistivity, NiZn ferrite, Co ferrite, CoZn ferrite and composite ferrite containing such ferrites as main components are especially desirable as ferrite for coating the surface of the fine ferromagnetic metal or intermetallic compound particles and insulating the fine particles from one another.

For the composite magnetic material of the present invention, the ferrite covering layer for covering the surface of fine ferromagnetic metal or intermetallic compound particles is not limited to have a particular thickness if it can enhance electrical resistance between the particles by retaining the ferrite covering layer on the formed body after compression forming. Its thickness is preferably 20 nm or more, and more preferably 50 nm or more. But, when a ratio of ferrite increases, an effect of obtaining a composite magnetic material having high saturation magnetization by using the fine metal or intermetallic compound particles having high saturation magnetization and by combining becomes low. Therefore, in view of a volume ratio of the composite magnetic material, a ratio of ferrite is desirably 50% or less, and more desirably 20% or less, but it is preferably at least 1% to obtain a high electrical resistivity.

For the composite magnetic material of the invention, the average particle diameter of the fine ferromagnetic metal or intermetallic compound particles is desirably selected so that the ferrite covering layer is not damaged badly by compression forming, and a formed body retaining a high electrical resistivity can be obtained with ease. Such fine ferromagnetic metal or intermetallic compound particles are desired to have an average particle diameter of 100 μm or less, and more preferably 30 μm or less. The inventor has found that the reduction in average particle diameter described above decreases damage to the ferrite covering layer at the time of compression forming, and a formed body with a high electrical resistivity can be obtained with ease. It is not thoroughly clarified yet why such effects can be obtained, but it is presumed that an absolute value of a stress applied to the particles at the compression forming becomes small by decreasing the average particle diameter of the fine ferromagnetic metal or intermetallic compound particles, so that damage to or deformation of the particles is decreased, breakage of the ferrite covering layer is also decreased, and the formed composite magnetic material has a high electrical resistivity.

For the formed composite magnetic material to have a high electrical resistivity as described above, it is advantageous that the fine ferromagnetic metal or intermetallic compound particles have a smaller average particle diameter, but if the average particle diameter is too small, it become hard to secure a magnetic property and to obtain a necessary relative permeability. Therefore, to secure the relative permeability, the average particle diameter is preferably 20 nm or higher, and more preferably 50 nm or higher.

The composite magnetic material of the present invention comprises the fine ferromagnetic metal or intermetallic compound particles of a soft magnetic substance and may be a composite magnetic material which comprises fine particles having a substantially spherical shape and small shape anisotropy, coated with insulating magnetic ferrite, and subjected to compression forming. When the composite magnetic material undergone the compression forming is magnetically isotropic, it can be used without suffering from a restriction on the directions of the material.

For the composite magnetic material of the present invention, the fine ferromagnetic metal or intermetallic compound particles may be fine particles having high magnetic anisotropy or fine particles having shape anisotropy such as a flat plate or a rod as a particle shape. The fine particles having shape anisotropy can have the directions of fine particles aligned in a compression forming step to give anisotropy to the formed composite magnetic material. And, the fine particles having high magnetic anisotropy can have the directions aligned by applying an external magnetic field at the time of compression forming.

The composite magnetic material of the invention can have a configuration that the fine ferromagnetic metal or intermetallic compound particles coated with insulating ferrite have particle size distribution and gaps between large particles are filled with small particles. Thus, a particle filling ratio can be enhanced, and high saturation magnetization can be obtained by the high filling ratio.

To obtain a high magnetic permeability and a high magnetic loss in a prescribed high-frequency region, a natural resonance frequency of the composite magnetic material can be adjusted. For example, as a metal magnetic material, fine ferromagnetic metal or intermetallic compound particles of magnetic anisotropic constant K_{A} and saturation magnetization Mₛ having an appropriately high value in a ratio K_{A}/M_{S} are selected for use, so that natural resonance frequency f=γ(K_{A}/M_{S})/2π can be adjusted to obtain a high magnetic permeability and a high magnetic loss in a prescribed high-frequency region.

The composite magnetic material of the invention may also be a composite magnetic material which is obtained by coating the fine ferromagnetic metal or intermetallic compound particles with a ferrite layer mixed with ultra-fine ferrite particles and compression forming the mixed particles. The inventor has found that a composite magnetic material having both a high filling ratio and a high electrical resistivity can be obtained by mixing ultra-fine ferrite particles with the fine ferromagnetic metal or intermetallic compound particles coated with a ferrite layer. It is presumed that, when the fine ferromagnetic metal or intermetallic compound particles coated with the ferrite layer are added the ultra-fine ferrite particles having a particle size substantially smaller than the fine particles, the ultra-fine ferrite particles serve as a lubricant at the time of compression forming to fill the gaps in the formed fine ferromagnetic particles, so that the fine ferromagnetic particles and the covering layer are not broken, and a high density composite magnetic material can be obtained while retaining a high insulating property.

The ultra-fine ferrite particles mixed with the fine ferromagnetic particles may have an average particle diameter substantially smaller than that of the fine ferromagnetic particles, preferably 100 nm or less, and more preferably 30 nm or less. A mixing amount of the ultra-fine ferrite particles is preferably 3% or more in volume ratio, and more preferably 6% or more, to the fine ferromagnetic particles coated with the ferrite layer so that the described action and effect can be obtained. Meanwhile, to secure a prescribed magnetic property, a mixing amount of the ultra-fine ferrite particles is preferably 30% or less, and more preferably 15% or less.

For the composite magnetic material of the present invention, an amorphous ferrite phase can be used for the ferrite layer to cover the fine ferromagnetic metal or intermetallic compound particles by selecting a condition for ferrite plating. By using amorphous ferrite having a high electrical resistivity for the ferrite layer covering the fine ferromagnetic metal or intermetallic compound particles, the electrical resistivity of the composite magnetic material can be increased as compared with the use of a crystalline ferrite layer. For example, an amorphous ferrite covering layer can be formed by covering an amorphous layer having the same chemical composition as that of rare-earth iron garnet by chelation ferrite plating. The amorphous ferrite can be used together with crystalline ferrite to cover the fine ferromagnetic metal or intermetallic compound particles.

In the method of producing the composite magnetic material of the invention, it is desirable to use ultrasonic excitation ferrite plating using ultrasonic excitation for the ferrite covering step by ferrite plating. By employing the ultrasonic excitation ferrite plating using the ultrasonic excitation, a firm ferrite covering layer can be formed uniformly on the surface of fine ferromagnetic metal or intermetallic compound particles. Thus, good-quality fine ferromagnetic metal or intermetallic compound particles coated with ferrite can be obtained stably with good productivity.

According to the method of producing a composite magnetic material of the invention, a composite magnetic material having both a high insulating property and a high permeability can be obtained by using the ferrite plating to form a good-quality film on the fine ferromagnetic metal or intermetallic compound particles and compression forming the fine particles.

For example, the ferrite-plated layer can be formed on the fine ferromagnetic metal or intermetallic compound particles as follows. The fine ferromagnetic metal or intermetallic compound particles are dispersed in a ferrite plating reaction solution, which contains divalent iron ion salt such as FeCl₂, divalent metal ion salt such as MCl₂, and trivalent iron ion such as FeCl₃ if necessary, and ferrite plating is performed while keeping the solution at a fixed temperature in a range of room temperature to less than 100° C., e.g., 80° C. Here, the ferrite plating can be performed by, for example, gradually adding an oxidizing agent such as sodium nitrite NaNO₂ to oxidize while vigorously moving the solution by applying ultrasonic waves by an ultrasonic horn, adjusting a pH value with NH₄OH or the like by a pH controller, and immersing the fine ferromagnetic metal or intermetallic compound particles into a substantially neutral reaction solution. Thus, the fine ferromagnetic metal or intermetallic compound particles can have the covering layer of the ferrite plating formed on the surface without being affected by the ferrite plating reaction solution.

Then, the fine ferromagnetic metal or intermetallic compound particles coated with the ferrite-plated layer can be subjected to the compression forming to obtain a formed body. It is presumed that the inside is a metal or intermetallic compound, which is plastically deformed by the compression forming to form the formed body.

According to the present invention, for the compression forming of the fine ferromagnetic metal or intermetallic compound particles coated with ferrite, there can be used any type such as uniaxial compression forming and compression roll forming which apply a pressure to compress from, for example, upper and lower directions by a mold, and isotropic pressure compression forming which applies a pressure to compress from all directions with fine particles charged into a rubber mold; heat isostatic compression (HIP) forming and warm isostatic pressure compression (WIP) forming which warmly perform the above forming; and hot uniaxial compression forming and hot isostatic compression (HIP) forming which perform the above forming with application of heat. Such compression forming may be conducted one time or plural times, and a different compression forming method may also be employed at the same time.

The temperature at which such compression forming is performed should be a temperature where formability is improved and not limited to a particular temperature if the ferrite covering layer can be retained. And it is desirable to perform the compression forming at temperatures of 200 to 500° C. at which forming is facilitated and the ferrite covering layer can be kept, and more desirably at temperatures of 300 to 400° C. The pressure for the compression forming is desirably a pressure at which a good formed body can be obtained and the ferrite covering layer can be retained, preferably 200 to 2000 MPa, and more preferably 400 to 1000 MPa. When a higher temperature is selected for the compression forming, plasticity of the fine ferromagnetic metal or intermetallic compound particles is improved, and forming can be made at a lower pressure. Therefore, it is desired to select a lower forming pressure and to select a forming temperature as high as possible in a temperature range, in which an insulating ferrite phase can be retained, in order to perform forming.

In the method of producing the composite magnetic material of the invention, a lubricant for forming and an auxiliary for forming, such as stearate and wax, can be used. But, the lubricant and the auxiliary for forming are desired to volatilize or the like from the formed body when heated, so that they do not remain in the composite magnetic material. The lubricant is particularly effective when used on the surface of the die inside wall where the mold and the fine particles are contacted.

The fine ferromagnetic metal or intermetallic compound particles used for the production of the composite magnetic material of the invention can be those produced from an oxide or the like by a gas reduction process or a solid reduction process, or those produced by various types of production methods such as a thermal decomposition method of carbonyl metals, an electrolysis, a mechanical pulverization method and a spray method (atomizing method).

The fine ferromagnetic metal or intermetallic compound particles used for the production of the composite magnetic material according to the invention can have various types of shapes such as a sphere, an ellipse, a needle, an acute angled, a branch, a fiber, a plate, a cube and a sphere, which can be used alone or as a combination of plural types of shapes.

The fine ferromagnetic metal or intermetallic compound particles used for the production of the composite magnetic material can be selected considering magnetic properties such as saturation magnetization, magnetic anisotropy, a ferrite coating property, and a compression forming property. And, the particle size distribution can also be selected appropriately considering the magnetic properties, a filling property, a compression forming property, and the like.

In the method of producing the composite magnetic material of the invention, the fine ferromagnetic metal or intermetallic compound particles preferably used have an average particle diameter of 100 μm or less, and more preferably 30 μm or less. When the average particle diameter is made small, damage to the ferrite covering layer at compression forming is decreased, and a formed body having a high electrical resistivity can be obtained with ease. To obtain a necessary relative permeability while retaining the magnetic properties, the average particle diameter is preferably 20 nm or more, and more preferably 50 nm or more.

In the method of producing the composite magnetic material of the invention, addition of ultra-fine ferrite particles to the fine ferromagnetic metal or intermetallic compound particles coated with the ferrite layer in the compression forming step facilitates the compression forming, and a high filling ratio and a high electrical resistivity of the composite magnetic material formed by compression forming can be obtained.

As the fine ferromagnetic particles coated with the ferrite layer, those recovered together with the ultra-fine ferrite particles produced in a plating solution can be used. Specifically, the ultra-fine ferrite particles produced in the plating solution are kept mixed in the fine ferromagnetic particles without removing so to facilitate the compression forming and can be used to obtain a high filling ratio and a high electrical resistivity of the composite magnetic material formed by compression forming.

As the above-described ultra-fine ferrite particles to be added at the compression forming of the fine ferromagnetic particles coated with the ferrite layer, the ultra-fine ferrite particles, which are produced by a ferrite plating reaction in an atmosphere system and at room temperature, can be used preferably.

As the ferrite coating step in the method of producing the composite magnetic material according to the invention, the process of the ferrite plating reaction to cover the fine ferromagnetic particles with ferrite can be performed plural times with a step of drying the fine ferromagnetic particles included between them.

And, as the ferrite coating step in the method of producing the composite magnetic material according to the invention, the process of the ferrite plating reaction to cover the fine ferromagnetic particles with ferrite can be performed plural times with a step of forming an organic or inorganic layer included between them.

Besides, as the ferrite coating step in the method of producing the composite magnetic material according to the. invention, the process of the ferrite plating reaction to cover the fine ferromagnetic particles with ferrite can be performed plural times with the forming of an oxide amorphous layer by a chelation ferrite plating method included between them.

Thus, the process of the ferrite plating reaction is performed plural times with the forming of the organic or inorganic layer included, so that adhesive force of the ferrite plated layer can be enhanced. As a result, an electrical resistivity of the composite magnetic material obtained by compression forming of the fine ferromagnetic particles coated with the ferrite can be enhanced.

In the method of producing the composite magnetic material according to the invention, the chelation ferrite plating method can also be used as a ferrite covering step to form an oxide amorphous layer, so that a covering layer having a high resistivity can be formed.

In the method of producing the composite magnetic material according to the invention, high-frequency induction heating can be used as heating means in the compression forming step. By using the high-frequency induction heating in the compression forming step, a filling ratio of the formed composite magnetic material can be increased.

Furthermore, in the method of producing the composite magnetic material according to the invention, discharge plasma heating can be used as the heating means in the compression forming step to enhance a filling ratio of the formed composite magnetic material.

Then, embodiments of the invention will be described in further detail with reference to the attached drawings.

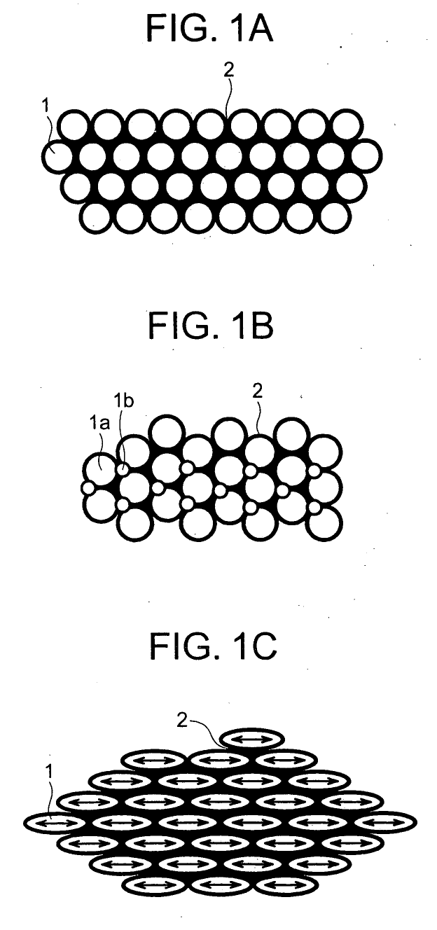

FIG. 1 is a diagram schematically showing an example of an arrangement of fine particles of the composite magnetic material according to an embodiment of the invention. FIG. 1A shows a composite magnetic material formed by covering the surface of fine ferromagnetic metal or intermetallic compound particles 1, which are substantially spherical, with insulating ferrite 2. This composite magnetic material is isotropic and can be used without restrictions on the directions of the material.

FIG. 1B schematically shows a structure in that fine ferromagnetic metal or intermetallic compound particles 1a and 1b having the surface coated with the ferrite layer 2 are mixed to have a particle size distribution, and gaps formed between the large particles la when they are filled are sequentially filled with the small particles 1b to enhance a particle filling ratio.

FIG. 1C schematically shows a composite magnetic material in which the fine ferromagnetic metal or intermetallic compound particles 1 are fine particles having high magnetic anisotropy in the direction indicated by arrows, the surface of the fine particles is coated with the insulating ferrite 2, and the directions of the fine particles having the magnetic anisotropy are aligned by a compression forming process. Here, the fine ferromagnetic metal or intermetallic compound particles 1 and the ferrite 2 have a considerably different saturation magnetization value from each other, so that magnetic shape anisotropy based on a particle shape is possessed even in a state that the particles are undergone the compression forming as shown in FIG. 1C. This composite magnetic material can attain higher properties by utilizing its directionality.

FIG. 1 shows an example of using the fine particles having a simple shape, such as spherical fine particles or flat fine particles, as the fine ferromagnetic particles of a composite magnetic material of the invention, but the fine ferromagnetic particles of the composite magnetic material of the invention are not limited to such fine particles having a simple shape, but the fine particles having a more complex shape as described above can be used, and they can also be used in combination.

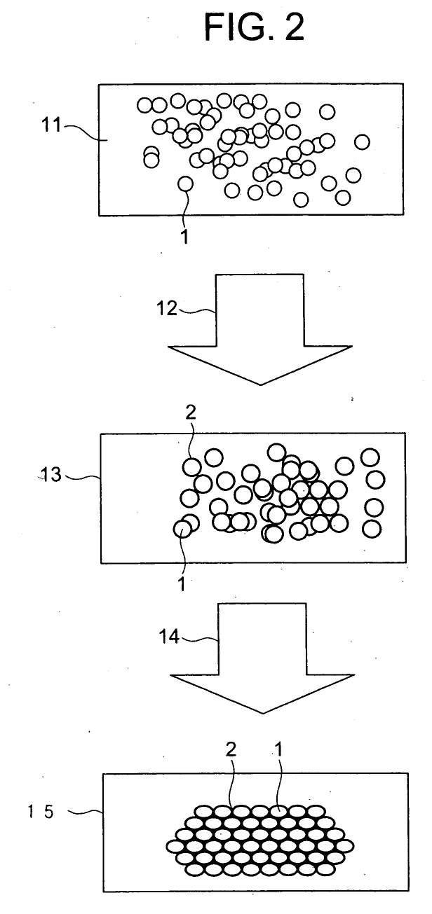

FIG. 2 simply shows a flow of the process of one embodiment of the method of producing the composite magnetic material of the invention. In FIG. 2, powder 11 comprising the fine ferromagnetic metal or intermetallic compound particles 1 is subjected to ferrite plating in an aqueous solution of normal temperature (3 to 100° C.) in a ferrite plating process 12 to become powder 13 of fine ferromagnetic metal or metal oxide particles having the surface coated with the ferrite layer 2.

This ferrite plating process comprises as follows. For example, an aqueous solution of divalent metal chloride such as Fe²⁺, Ni²⁺, Co²⁺, Zn²⁺ as the reaction solution is used with its temperature kept at 100° C. or below, e.g., 80° C., a pH controller is used to keep a constant pH value by adding, for example, an aqueous NH₄OH solution as a pH adjuster, and OH groups on the surface of the fine ferromagnetic particles is caused to adsorb divalent metal ions such as Fe²⁺ on the surface so as to release H⁺. The OH groups exist on the surface of the fine ferromagnetic metal or intermetallic compound particles. For example, sodium nitrite (NaNO₂) is used here as the oxidizing agent to oxidize the adsorbed Fe²⁺ ions partly or entirely so as to change to Fe³⁺ to form a ferrite crystal layer on the surface of the particles. The OH radical is present on the surface of the formed ferrite crystal layer, and the process of causing the OH radical to adsorb the divalent metal ions such as Fe²⁺, Ni²⁺, Co²⁺, Zn²⁺ on the surface so to release H⁺ and oxidizing the adsorbed Fe²⁺ ions partly or entirely to change into F⁺ is repeated to grow a ferrite layer having a spinel structure on the surface of the particles. Then, the fine particles coated with the ferrite layer are washed and dried.

Production of particles of ferrite ((MFe)₃O₄, where M denotes a divalent metal) from the aqueous solution was already known, but the method of depositing the ferrite film on the solid surface such as particles was invented by the present inventor (Journal of the Magnetics Society of Japan, Vol. 22, pp. 1225-1232 (1998)). The present inventor has also developed ultrasonic excitation ferrite plating (Abe et al., IEEE Trans. Magn., Vol. Mag. 33 3649 (1997)) to perform ultrasonic excitation at the time of ferrite plating, so to improve the forming of a ferrite layer suitable for the composite magnetic material of the present invention and to make it possible to stably produce the composite magnetic material of the invention.

This powder is formed into a composite magnetic material 15 by a compression forming process 14 of FIG. 2. This compression forming process performs the compression forming by compression under pressure in the uniaxial direction and can obtain a good formed body with good productivity. The good forming property can be obtained by performing the compression forming with a temperature of the fine ferromagnetic particles raised to approximately 300 to 400° C. though variable depending on the properties of the fine ferromagnetic particles.

To raise the temperature of the fine ferromagnetic particles, high-frequency induction heating can be employed, so that heating can be made effectively, and the forming property can be enhanced. Effective heating can also be made by a discharge plasma heating method. The discharge plasma heating method is described by Setsuo Yamamoto, Nobutsugu Tanamachi, Shinji Horie, Hiroki Kurisu, Mitsuru Matsuura, Koichi Isida; Powder and Powder Metallurgy, 47, (7) 757 (2000), according to which a cylindrical graphite die and a cylindrical punch are assembled, a powder sample is charged in it, it is sandwiched between punch electrodes and compressed, and DC pulse current is passed at the same time, so to heat the sample from outside by Joule heat of the current passing through the punch and die, and the DC current is also passed through the power sample to produce high energy of discharge plasma between the power particles.

For the compression forming process, isostatic compression forming which applies isotropic compression under pressure to the powder can be employed. A warm isostatic pressure(WIP) forming method which uses heat-resistant oil as a pressure medium and performs isostatic compression forming while heating, or a hot isostatic pressure (HIP) forming method which uses gas as a pressure medium and performs static compression forming by heating can also be used.

The composite magnetic material 15 produced as described above is a formed body of the particles having the fine ferromagnetic metal or intermetallic compound particles 1 coated with the ferrite layer 2, and the fine ferromagnetic metal or intermetallic compound particles 1 are electrically insulated from one another by the ferrite layer 2 to form an insulating magnetic material. On the other hand, the composite magnetic material 15 is a magnetically connected and integrated magnetic material because the fine ferromagnetic metal or intermetallic compound particles are magnetically connected via the ferrite layer.

Then, examples of fine magnetic substance particles having a composite structure of metallic iron and NiZn ferrite will be described to explain the invention more specifically.

### EXAMPLE 1

A ferrite layer having an average thickness of 0.5 μm was formed on the surface of fine carbonyl iron particles having an average particle diameter of 4 μm by ferrite plating.

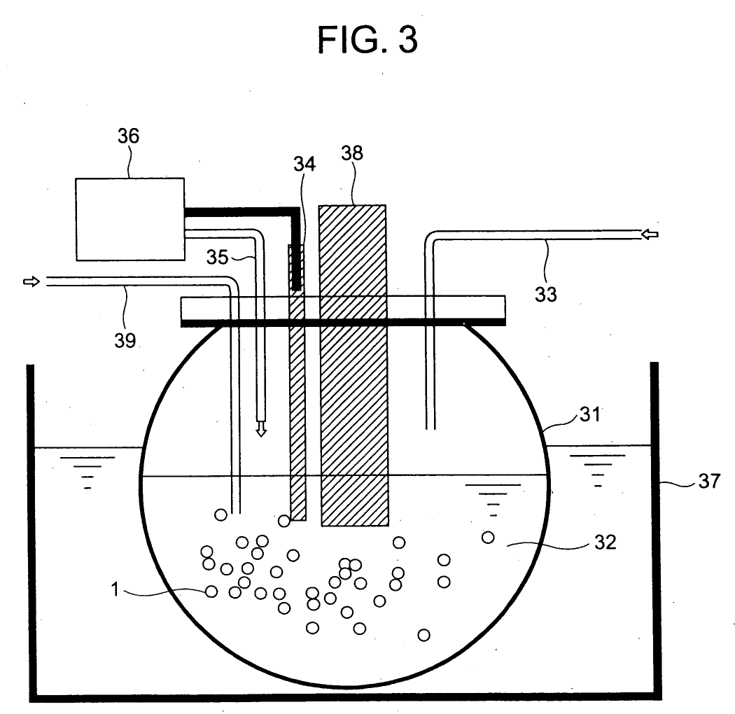

The ferrite plating was performed using a glass reaction vessel 31 (a volume of 500 ml) shown in FIG. 3 by immersing fine carbonyl iron spherical particles 1 which were fine metal magnetic substance particles into a reaction solution 32 and applying ultrasonic waves by an ultrasonic horn 38. Reference numeral 39 denotes a nitrogen gas supply pipe for previously removing an oxidizing property of the reaction solution. Conditions for ferrite plating are as follows.

Reaction solution:

FeCl₂(12 g/l)+NiCl₂(4 g/l)+ZnCl₂(0.5 g/l)

(To obtain a ferrite plated layer having a high resistivity and a spinel structure by supplying an oxidizing agent NaNO₂ through an oxidizing agent supply pipe 33 to partly oxidize Fe²⁺ into Fe³⁺.) pH: 6.0

(The pH value of the reaction solution is controlled by measuring by pH electrodes 34 and adjusting the supply of NH₄OH through an NH₄OH supply pipe 35 by a pH controller 36.) Temperature: 80° C. (Temperature is kept by a heating bath 37.)

Supersonic wave: Frequency 19.5 kHz, power 600 W (The reaction solution is shaken by the ultrasonic horn 38.) Plating time: 30 minutes

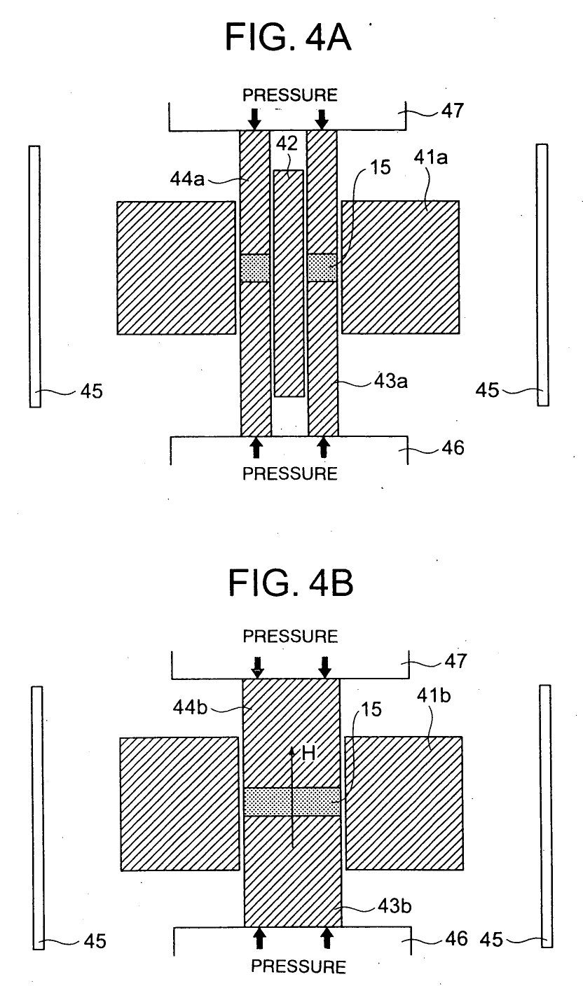

Then, fine magnetic substance particles having a composite structure of metallic iron and NiZn ferrite were formed by a compression forming device of which cross section is schematically shown in FIG. 4. A cylindrical formed body having an outside diameter of 8 mm and an inside diameter of 3 mm in cross section was obtained as shown in FIG. 4A, and a cylindrical or disc-like formed body having an outside diameter of 8 mm was obtained as shown in FIG. 4B.

In FIG. 4A, fine magnetic substance particles 13 having a composite structure of metallic iron and NiZn ferrite were supplied to the compression surface of a lower punch 43b which was inserted from below between a die 41a and a core rod 42, an upper punch 44a was inserted from above, and a pressure was applied. The powder 15 comprising the fine magnetic substance particles having the composite structure of the metallic iron and the NiZn ferrite was heated to 350° C. by a heating element 45 for heating and pressed by a pressure device (not shown) for applying a pressure of 785 MPa (8 ton weight/cm²) through plungers 46, 47 to obtain a cylindrical formed body of composite magnetic material.

Similarly, fine magnetic substance particles 13 having a composite structure of metallic iron and NiZn ferrite were supplied to the compression surface of a lower punch 43b which was inserted into a die 41b from below, an upper punch 44b was inserted from above, and a pressure was applied as shown in FIG. 4B. The compression forming of the fine magnetic substance particles 13 having the composite structure of the metallic iron and the NiZn ferrite heats to 350° C. of the same condition as above by the heating element 45 for heating and applies a pressure of 785 MPa by a pressure device (not shown) through the plungers 46, 47 for compression forming to form a cylindrical formed body of the composite magnetic material. This compression forming device can also perform orientation forming in a magnetic field by, for example, applying a magnetic field H, as shown in the drawing, from outside when compression forming is performed.

The composite magnetic material obtained as described above had fine iron particles coated with ferrite densely filled so to have the ferrite layer between the fine iron particles. And, the conductive fine metal magnetic substance particles were electrically insulated from one another by the ferrite layer to improve a high-frequency property of a relative permeability, and there was obtained a value of exceeding 10 in real part of the relative permeability at 2 GHz. And, the composite magnetic material obtained as described above had the fine particles densely filled, and the ferrite layer partly serves for the saturation magnetization, and a value greatly exceeding 1.0 T was obtained as a value of the saturation magnetization.

The above-described formed body having a cylindrical shape (toroidal with a rectangular cross section) was measured for a high-frequency relative permeability to find that a high-frequency relative permeability of 100 at 800 MHz was obtained. This value is a considerably large value as compared with that of a formed body having a maximum relative permeability of 7 which has fine carbonyl iron particles subjected to a surface coupling treatment and dispersed in high density. It indicates that the formed body of this example has the fine carbonyl iron particles magnetically bonded to one another by the ferrite layer. And, a relation between the relative permeability of the composite magnetic material and the frequency exceeds the Snoek's limit line on a relational curve of a relative permeability of the NiZn ferrite and a frequency, and also exceeds a limit line of the composite magnetic material which has the fine carbonyl iron particles filled into a resin at a high filling ratio.

### EXAMPLE 2

Ultra-fine NiZn ferrite particles were produced by the following method. Specifically, 100 ml of pure water was charged in a 300-ml beaker, and a reaction solution having 7.9552 g of FeCl₂.4H₂O, 10.812 g of FeCl₃.6H₂O, 6.656 g of NiCl₂.6H₂O and 1.636 g of ZnCl₂ dissolved as starting substances required for ferrite plating of 0.16 mol of Ni_{0.7}Zn_{0.3}Fe_{2.0}O₄ in 50 ml of pure water and 50 ml of a 0.15 mol NH₄Cl solution were added at a velocity of 5 ml/minute while stirring by a stirrer to cause a reaction. Specifically, the reaction was performed according to 50 ml/(5 ml/minute)=10 minutes. The product obtained by the reaction was washed and dried. Thus, ultra-fine NiZn ferrite particles having an average particle diameter of 8 nm were obtained.

To fine iron particles coated with the ferrite plating film produced by the same method as in Example 1 were added by 10% in volume ratio of the above-described ultra-fine NiZn ferrite particles, and compression forming was performed by the same procedure as in Example 1.

As a result, the pressure required to obtain a composite magnetic material having the same bulk density was decreased by about 20% by addition of the ultra-fine ferrite particles as compared with Example 1 in which the ultra-fine ferrite particles were not added. The composite magnetic material having the ultra-fine ferrite particles added had the electrical resistivity increased to about three times as compared with the composite magnetic material (the composite magnetic material of Example 1) having the same bulk density without addition of the ultra-fine ferrite particles.

### EXAMPLE 3

An NiZn ferrite layer having an average thickness of 15 nm was formed on the surface of fine carbonyl iron particles having an average particle diameter of 70 nm by ferrite plating according to the same procedure as in Example 1.

Then, the fine magnetic substance particles having a composite structure of the metallic iron and the Nizn ferrite were compression-formed by the same procedure as in Example 1 to densely fill the fine iron particles coated with ferrite and to intervene the ferrite layer between the fine iron particles so to obtain a composite magnetic material. There was obtained a value of exceeding 10 in real part of a high-frequency relative permeability of the formed body at 2 GHz.

### EXAMPLE 4

Fine iron particles were subjected to a ferrite plating reaction for ten minutes as described in Example 1, separated by a magnet and dried on filter paper at 60° C. Then, the fine particles were again subjected to the same ferrite plating reaction for 15 minutes and collected by a magnet again and dried on filter paper at 60° C. Subsequently, the fine particles were again subjected to the same ferrite plating reaction for 15 minutes, washed, separated and dried to obtain fine ferromagnetic particles coated with ferrite. The ferrite-covered fine ferromagnetic particles were subjected to compression forming by the same procedure as in Example 1 to obtain a composite magnetic material. The composite magnetic material obtained in this example was compared with the one obtained without the drying process in Example 1 to find that an electrical resistivity was increased to two to three times. It was because (1) the film thickness was increased by the incorporation of the drying process even if a total of the plating reaction time was same, and (2) the adhesive force of the ferrite layer to the surface of the fine ferromagnetic particles was increased, so that the separation of the ferrite film from the surface of the fine ferromagnetic particles in the compression forming process was suppressed. Reasons of (1) and (2) above are as follows.

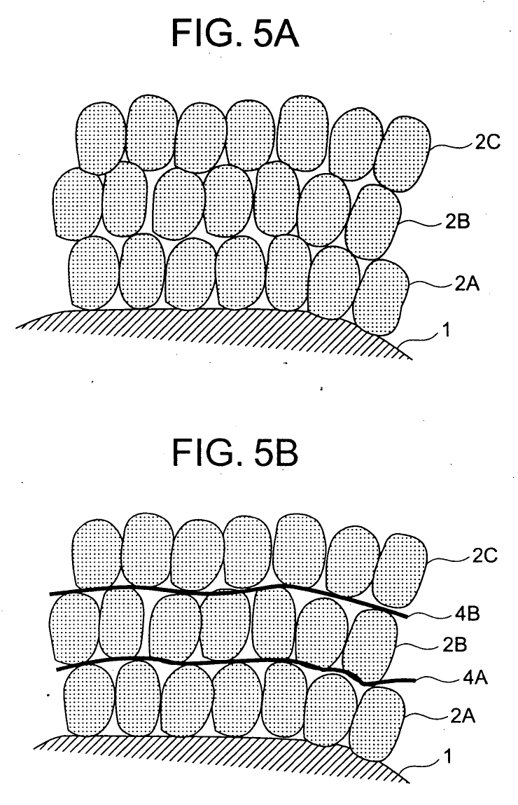

(1) A section of the fine ferromagnetic particles which were subjected to the ferrite plating three times with the drying process included after each plating was observed through a transmission electron microscope (TEM) to find a three-layered columnar structure as schematically shown in FIG. 5A. In FIG. 5A, reference 1 denotes fine ferromagnetic metal or intermetallic compound particles, and 2A, 2B and 2C each denotes a columnar ferrite layer. Growth of crystal grains having a columnar structure in the ferrite layer obtained by the ferrite forming reaction was interrupted by the incorporation of the drying process, and new columnar crystal grains were grown by the next ferrite reaction. It is known by the study of ferrite plating on a flat substrate made in the past that an adhesive force of the ferrite layer to the surface of the fine ferromagnetic particles is weakened by a stress acting between the crystal grains with the increase in diameter of the columnar crystal grains. The adhesive force was increased by suppressing the growth of the crystal grains by the incorporation of the drying process, namely “start over.”

(2) Generally, a growing velocity of the layer thickness by the ferrite plating tends to saturate with time, but an effect of saturating tendency can be suppressed by the “start over,” and a total film thickness was increased.

Thus, the incorporation of the drying process during the ferrite plating provided the ferrite layer with the multilayered structure as described above, and the film which had a good insulating property and was firm could be formed.

### EXAMPLE 5

Fine iron particles were subjected to the ferrite plating reaction for ten minutes as described in Example 1, separated by a magnet, washed with water, and dispersed into an aqueous solution of dextran in a density of 1.0 g/l ((C₆H₁₀O₆)n, n=1200 to 1800) at 60° C. with ultrasonic waves applied to adsorb a dextran monomolecular film to the surface of the ferrite layer formed on the fine iron particles. Then, the fine iron particles were again subjected to the same ferrite plating reaction for 15 minutes, separated by a magnet, washed with water, and dispersed into an aqueous solution of dextran in a density of 1.0 g/l ((C₆H₁₀O₆)n, n=1200 to 1800) at 60° C. with ultrasonic waves applied to adsorb a dextran monomolecular film to the surface of the ferrite layer formed on the fine iron particles. Subsequently, the fine particles were again subjected to the same ferrite plating reaction for 15 minutes, washed, separated and dried to obtain fine ferrite-covered ferromagnetic particles. The fine ferrite-covered ferromagnetic particles were subjected to the compression forming by the same procedure as in Example 1 to obtain a composite magnetic material.

The composite magnetic material of this example obtained as described above was not undergone through the drying process, but the electrical resistivity was increased to two to three times as compared with that in Example 1 in the same way as in Example 4.

A section of the fine ferromagnetic particles which were subjected to the ferrite plating three times with the adsorption of the dextran monomolecular film included after each plating as described above were observed through a transmission electron microscope (TEM) to find the same three-layered columnar structure as in Example 4 as schematically shown in FIG. 5B. In FIG. 5B, reference numeral 1 denotes fine ferromagnetic metal or intermetallic compound particles, and 2A, 2B and 2C each denotes a columnar ferrite layer. And, 4A and 4B denote an intermediate layer of the dextran monomolecular film. As shown in FIG. 5B, the growth of crystal grains having a columnar structure in the ferrite layer obtained by the ferrite forming reaction was interrupted by the incorporation of the dextran monomolecular film adsorption process, and new columnar crystal grains were grown by the next ferrite reaction.

Thus, the incorporation of the dextran monomolecular film adsorbing process during the ferrite plating provided the ferrite layer with a multilayered structure as described above, and the film which had a good insulating property and was firm could be formed.

### EXAMPLE 6

An inorganic amorphous Y₃Fe₅O₁₂ thin layer was deposited instead of the dextran monomolecular film deposited on the surface of the ferrite layer in Example 5.

The amorphous Y₃Fe₅O₁₂ thin layer was deposited by the method described below (Reference 1: Q. Zhang, T. Itoh, M. Abe, and M. J. Zhang; J. Appl. Phys., 75, (10), 6094 (1994)).

Specifically, using the ultrasonic ferrite plating device described in Example 1, fine carbonyl iron particles having an average particle diameter of about 4 μm were dispersed into pure water kept at 80° C. with ultrasonic waves (19.5 kHz, 600W) applied, ferrite plating was performed for ten minutes under the same conditions as in Example 1 to form a spinel ferrite layer, the fine iron particles were attracted by a magnet placed outside of the reaction solution, the reaction solution was flown out, and the fine iron particles were washed with water. Then, FeCl₂(0.5 g/l)+YCl3(2.0 g/l) adjusted to pH=5.8 as a reaction solution and NaNO₂(1 g/l)+CH₃COONH₄(4.0 g/l) adjusted to pH=7.1 as an oxidizing agent were supplied for 10 minutes to deposit an amorphous layer on the surface of the fine iron particles. Subsequently, the reaction solution was flown out while attracting the fine iron particles by a magnet approached from outside of the reaction vessel, the fine iron particles were washed with water, ferrite plating was performed for 10 minutes again in the same reaction solution under the same conditions as in Example 1 to form a spinel ferrite layer, and an amorphous layer was deposited again on the surface of the fine iron particles in the same procedure as described above. Besides, ferrite plating was performed again for 10 minutes under the same conditions as in Example 1 to form a spinel ferrite layer.

Thus, the growth of crystal grains in the ferrite layer was made to “start over” by the formation of the amorphous layer, so that the multilayered ferrite covering layer became more firm as compared with the case that the organic dextran which was a nonmagnetic substance was used, and the composite magnetic material obtained by compression forming of the fine ferromagnetic particles coated with ferrite had electrical resistance increased to about three times as compared with that obtained by the continuous ferrite plating performed for the same time in Example 1.

### EXAMPLE 7

The carbonyl iron spheres coated with the multilayered NiZn ferrite layer produced by the method described in Example 2 were pressed into a core shape using an alumina die, a punch and a core rod placed at the center of a high-frequency coil while conducting high-frequency induction heating under the conditions described below.

High frequency: 120 kHz, power: 300W

High-frequency coil: Inside diameter Φ70 mm, outside diameter Φ86 mm, 15 stages (height of 150 mm)

Die and piston: Alumina

The core-shaped composite magnetic material obtained had an initial magnetic permeability increased to about three times as compared with the one not undergone the induction heating.

### EXAMPLE 8

The core-shaped composite magnetic material was obtained by compression forming the carbonyl iron spheres, which were coated with the multilayered ferrite layer having the amorphous Y₃Fe₅O₁₂ film produced in Example 6 as an intermediate layer, while induction heating by the method described in Example 7. This composite magnetic material had its initial magnetic permeability increased to 2.5 times as compared with the one not undergone the induction heating.

### EXAMPLE 9

An inorganic amorphous Y₃Fe₅O₁₂ thin layer was directly formed on iron carbonyl spheres. The forming conditions were not different from those of Example 6 except that the reaction time was changed from 10 minutes to 30 minutes. The carbonyl iron spheres coated with the amorphous Y₃Fe₅O₁₂ film were subjected to compression forming to produce a composite magnetic material. The electrical resistivity was increased to ten times as compared with that in Example 5, and the initial magnetic permeability was increased to about two times.

The examples described above are merely parts of embodiments which can be conducted by the invention. According to the present invention, selection of individual conditions, such as a material composition, a fine particle shape and a grain size, a ferrite covering layer and forming conditions, of the metal or intermetallic compound magnetic substance allows to obtain composite magnetic materials having various properties. For example, one having a high relative permeability and suitably used in a relatively low frequency range can be obtained by selecting a relatively large particle diameter of several tens μm, and one usable in a microwave region can be obtained by selecting a small particle diameter or fine particles having appropriate magnetic anisotropy. Thus, various composite magnetic materials suitable for extensive uses and having a high insulating property and a high magnetic permeability can be obtained.

### INDUSTRIAL APPLICABILITY

According to the present invention, the composite magnetic material can be obtained by covering the surface of fine particles of metal magnetic material having high saturation magnetization with a high-resistant and firm ferrite layer and compression forming the fine particles. This composite magnetic material has the fine metal magnetic particles electrically insulated from one another but magnetically connected to one another, so that it has high saturation magnetization and high electrical resistance. And, a high magnetic permeability can be obtained. Besides, the process of covering the surface of the fine particles by ferrite plating is a good-quality process with favorable productivity. Therefore, the composite magnetic material of the present invention can be used extensively for an electromagnetic-wave absorber at a high frequency, an inductance element and others.

What is claimed is:

1. A composite magnetic material, comprising fine ferromagnetic metal or intermetallic compound particles and a ferrite layer for covering the fine ferromagnetic metal or intermetallic compound particles, wherein the fine ferromagnetic metal or intermetallic compound particles covered with the ferrite layer are compression-formed.

2. The composite magnetic material according to claim 1, wherein the ferrite layer covering the fine ferromagnetic metal or intermetallic compound particles is formed by ferrite plating.

3. The composite magnetic material according to claim 2, wherein the ferrite plating is ultrasonic excitation ferrite plating.

4. The composite magnetic material according to claim 1, wherein the saturation magnetization of the fine ferromagnetic metal or intermetallic compound particles is higher than that of the ferrite layer.

5. The composite magnetic material according to claim 1, wherein the fine ferromagnetic metal or intermetallic compound particles have an average particle diameter of 20 nm or more and 100 μm or less.

6. The composite magnetic material according to claim 1, wherein the fine ferromagnetic metal or intermetallic compound particles are formed of a magnetic anisotropic metal or intermetallic compound.

7. The composite magnetic material according to claim 1, wherein the composite magnetic material is a compression-formed composite comprising a mixture of the fine ferromagnetic metal or intermetallic compound particles covered with the ferrite layer and ultra-fine ferrite particles.

8. The composite magnetic material according to claim 1, wherein the ferrite layer has amorphous ferrite as a main phase.

9. A method of producing a composite magnetic material, comprising:
a ferrite covering step for covering the surface of fine ferromagnetic metal or intermetallic compound particles with a ferrite layer by dispersing the fine ferromagnetic metal or intermetallic compound particles in a ferrite plating reaction solution and plating ferrite; and
a compression forming step for compression forming the fine ferromagnetic metal or intermetallic compound particles covered with the ferrite layer.

10. The method of producing a composite magnetic material according to claim 9, wherein the ferrite covering step is ultrasonic excitation ferrite plating exciting using ultrasonic waves.

11. The method of producing a composite magnetic material according to claim 9, wherein the fine ferromagnetic metal or intermetallic compound particles have an average particle diameter of 20 nm or more and 100 μm or less.

12. The method of producing a composite magnetic material according to claim 9, wherein ultra-fine ferrite particles are added to the fine ferromagnetic particles covered with the ferrite layer in the compression forming step.

13. The method of producing a composite magnetic material according to claim 12, wherein ultra-fine ferrite particles produced at a ferrite plating reaction in an atmosphere system and at room temperature are used as the ultra-fine ferrite particles.

14. The method of producing a composite magnetic material according to claim 9, wherein the fine ferromagnetic particles covered with the ferrite layer used for compression forming are collected together with the ultra-fine ferrite particles produced in the plating solution and have the ultra-fine ferrite particles

15. The method of producing a composite magnetic material according to claim 9, wherein the ferrite covering step performs a ferrite plating reaction process for covering the fine ferromagnetic particles with ferrite plural times with a step of drying the fine ferromagnetic particles included between the plating reaction processes.

16. The method of producing a composite magnetic material according to claim 9, wherein the ferrite covering step performs the ferrite plating reaction process for covering the fine ferromagnetic particles with ferrite plural times with the formation of an organic or inorganic layer included between the plating reaction processes.

17. The method of producing a composite magnetic material according to claim 9, wherein the ferrite covering step performs the ferrite plating reaction process for covering the fine ferromagnetic particles with ferrite plural times with the formation of an oxide amorphous layer by a chelation ferrite plating method included between the plating reaction processes.

18. The method of producing a composite magnetic material according to claim 9, wherein the ferrite covering step forms an oxide amorphous layer by a chelation ferrite plating method.

19. The method of producing a composite magnetic material according to claim 9, wherein the compression forming step employs heating by high-frequency induction heating.

20. The method of producing a composite magnetic material according to claim 9, wherein the compression forming step employs heating by discharge plasma heating.
